(19) United States
(12) Patent Application Publication
(10) Pub. No.: US 2010/0261075 A1
(43) Pub. Date: Oct. 14, 2010

(54) FUEL SENSOR-LESS CONTROL METHOD FOR SUPPLYING FUEL TO FUEL CELL

(75) Inventors: Charn-Ying Chen, Taoyuan County (TW); Chun-Lung Chang, Taoyuan County (TW); Der-Hsing Liou, Taoyuan County (TW); Hou-Chin Cha, Taoyuan County (TW); Rui-Xiang Wang, Taoyuan County (TW)

Correspondence Address: WPAT, PC;INTELLECTUAL PROPERTY ATTORNEYS, 7225 BEVERLY ST., ANNANDALE, VA, 22003, US

(73) Assignee: Institute of Nuclear Energy Research Atomic Energy Council, Executive Yuan, Taoyuan County (TW)

(21) Appl. No.: 12/612,801

(22) Filed: Nov. 5, 2009

(30) Foreign Application Priority Data
Apr. 10, 2009 (TW) 098111985

(51) Int. Cl. H01M 8/00

(52) U.S. Cl. 429/428; 429/452

(57) ABSTRACT

The present invention provides a fuel sensor-less control method for supplying fuel to a fuel cell, in which a fixed control amount is determined for controlling the fuel supply of fuel cell, and then a feeding timing of the fixed fuel quantity is determined by integrating characteristic values generated from the fuel cell within the limit of fixed control amount. In another embodiment, it is further comprising a step of determining the variation profile associated with the characteristic values during the period so as to judge whether it is necessary to feed the fuel into the fuel cell or not. By means of the present invention, the supplying of fuel to the fuel cell under dynamic loadings can be effectively controlled for optimizing the performance of the fuel cell as well as reducing the cost without installing any fuel concentration sensor.

### FIELD OF THE INVENTION

The present invention relates to a method for supplying fuel to fuel cell, and more particularly, to a fuel supplying method capable of determining a specific amount of a fuel to be injected into a fuel cell according to the measurement of a function relating to the time integral of a specific characteristic value resulting from the reaction of the fuel cell.

### BACKGROUND OF THE INVENTION

A fuel cell is an electrochemical energy conversion device, similar to a battery in that it provides continuous DC power, which converts the chemical energy from a fuel directly into electricity and heat. For example, one type of fuel cell includes a proton exchange membrane (PEM), often called a polymer electrolyte membrane, that permits only protons to pass from anode to cathode of the fuel cell. At the anode, hydrogen (a fuel) is reacted to produce protons that pass through the PEM. The electrons produced by this reaction travel through circuitry that is external to the fuel cell to form an electrical current. At the cathode, oxygen is reduced and reacts with the protons to form water. When operated directly on hydrogen, the fuel cell produces energy with water as the only by-product. Unlike a battery, which is limited to the stored energy within, a fuel cell is capable of generating power as long as fuel is supplied continuously. Although hydrogen is the primary fuel source for fuel cells, the process of fuel reforming allows for the extraction of hydrogen from more widely available fuels such as natural gas and propane or any other hydrogen containing fuel. For a growing number of power generators and users, fuel cells are the key to the future since it is an environment-friendly power source with high energy conversion efficiency.

Among the fuel cells, a direct methanol fuel cell or so called DMFC is a promising candidate for portable applications in recently years. The difference between DMFC and other power generating devices, such as PEMFC, is that the DMFC takes methanol as fuel in substitution for hydrogen. Because of utilizing liquid methanol as fuel for reaction, the DMFC eliminates the on board H₂ storage problem so that the risk of explosion in the use of fuel cells is avoided, which substantially enhances the convenience and safety of fuel cells and makes DMFC more adaptable to portable electronic appliances such as Laptop, PDA, GPS and etc, in the future.

During the electrochemical reaction occurred in the fuel cell, the fuel concentration is a vital parameter affecting the performance of the liquid feed fuel cell system. However, DMFC suffers from a problem that is well known to those skilled in the art: methanol cross-over from anode to cathode through the membrane of electrolyte, which causes significant loss in efficiency. It is important to regulate the supplying of fuel appropriately to keep methanol concentration in a predetermined range whereby DMFCs system can operate optimally. For example, a fuel sensor, such as methanol concentration sensor disclosed in the prior art, is utilized to detect the concentration of methanol so as to provide information for controlling system to judge a suitable timing to supply methanol. Although the foregoing method is capable of controlling the concentration of the fuel, it still has the drawbacks as following: (1) the complexity and cost of the fuel cell system are increased; (2) considering the aging of the membrane electrode assembly (MEA) of the fuel cell, the fuel concentration sensor used therein will have to be calibrated in a regular base for maintaining a specific level of accuracy so that a lot of experimental effort like calibration is necessary through the use of concentration sensor. Moreover, the control complexity of the fuel cell using fuel concentration sensor is increased as the measurement of the fuel concentration sensor can be easily affected by temperature variation.

In order to reduce the cost and complexity caused by the additional concentration sensor in the prior arts, a couple of fuel sensor-less control for DMFCs approaches have been disclosed to decrease the cost and complexity of the fuel cells system and improve the stability of fuel cell operation by monitoring one or more of the fuel cells' operating characteristics. For instance, in U.S. Pat. No. 6,824,899, a method is provided to optimize the fuel concentration by detecting the short circuit current or open circuit potential. However, since the method requires to short circuit the fuel cell in periodical manner for current detection, it is easily to cause damage to the fuel cells and thus affects the stability and lifespan of the fuel cells system.

According to the drawbacks of the prior arts described under, it deserves to provide a method for supplying fuel to fuel cells to solve the problem of the prior arts.

### SUMMARY OF THE INVENTION

The object of the present invention is to provide a fuel sensor-less control method for supplying fuel to a fuel cell, capable of determining a timing and amount for injecting a fuel into the fuel cell according to the comparison between a time integral and a fixed control amount for achieving the purpose of optimizing the performance of the fuel cell, whereas the time integral is obtained from the integration of a specific characteristic value resulting from the reaction of the fuel cell.

It is another object of the invention to provide a fuel sensor-less control method for supplying fuel to a fuel cell, which performs a numerical operation/comparison upon a characteristic value measured from a fuel cell when the fuel cell is subjected to a load for using the result of the numerical operation/comparison to determine when to inject fuel into the fuel cell, and thereby, since the timing and quantity for fuel injection is determined without the use of any fuel concentration sensor, not only the manufacturing cost of the fuel cell is reduced, but also the control precision and system reliability of the fuel cell as well as its durability are all being enhanced.

It is further another object of the invention to provide a fuel sensor-less control method for supplying fuel to a fuel cell, capable of enabling the fuel cell to operate under a comparatively wider fuel concentration range without being affected by temperature variation and the aging of its membrane electrode assembly (MEA), and thereby, not only the fuel efficiency of the fuel cell is increased, but also its system response time to load variation is shortened. Moreover, since the aforesaid method enables a fuel cell to function without the need for any fuel concentration sensor, not only the volume and weight of the fuel cell is reduced so that the power density of the fuel cell is increased, but also the manufacturing cost and the system complexity are reduced, as well as its durability and reliability are enhanced.

To achieve the under object, the present invention provides a fuel sensor-less control method for supplying fuel to a fuel cell, which comprises the steps of: (a) injecting a fixed control amount of fuel into a fuel cell as the fuel cell, being subjected to a load, is comprised of: at least one cell, each composed of an anode, a cathode and a proton exchange membrane; (b) obtaining a time integral of a specific characteristic value resulting from the reaction of the fuel cell to be used for determining a timing of fuel injection when the fuel cell is operating with the fuel supply under the fixed control amount of fuel.

In another embodiment, the present invention provides a fuel sensor-less control method for supplying fuel to a fuel cell, which comprises the steps of: (a) injecting a fixed control amount of fuel into a fuel cell as the fuel cell, being subjected to a load, is comprised of: at least one cell, each composed of an anode, a cathode and a proton exchange membrane; (b) registering the time variation of a specific characteristic value measured from the fuel cell when the fuel cell is operating with the fuel supply under the fixed control amount of fuel; (c) making an evaluation to determine whether or not to inject the fuel into the fuel cell according to a curve profiling the time variation of the specific characteristic value at the time when the obtained time integral is equal to the fixed control amount.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a flow chart depicting steps of a fuel sensor-less control method for supplying fuel to fuel cell according to a first embodiment of the invention.

FIG. 2A is a schematic diagram showing a fuel cell system of the invention.

FIG. 2B and FIG. 2C are schematic diagrams showing two different fuel cell systems of the invention.

FIG. 3 is a flow chart depicting steps of a fuel sensor-less control method for supplying fuel to fuel cell according to a second embodiment of the invention.

FIG. 4A plots a current curve of a fuel cell operating under the fuel supplying method of the invention.

FIG. 4B plots a power curve of a fuel cell operating under the fuel supplying method of the invention.

FIG. 5 is a flow chart depicting steps of a fuel sensor-less control method for supplying fuel to fuel cell according to a third embodiment of the invention.

FIG. 6 is a flow chart depicting steps of a fuel sensor-less control method for supplying fuel to fuel cell according to a fourth embodiment of the invention.

FIG. 7A plots another current curve of a fuel cell operating under the fuel supplying method of the invention.

FIG. 7B plots another power curve of a fuel cell operating under the fuel supplying method of the invention.

FIG. 8 is a flow chart depicting steps of a fuel sensor-less control method for supplying fuel to fuel cell according to a fifth embodiment of the invention.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

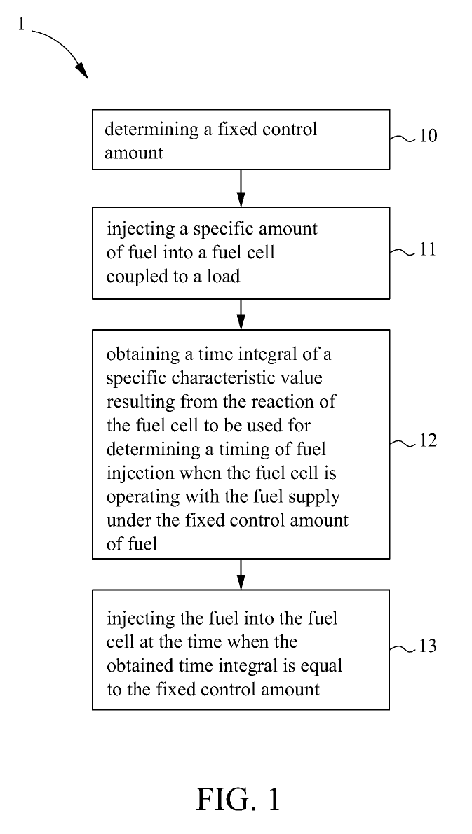

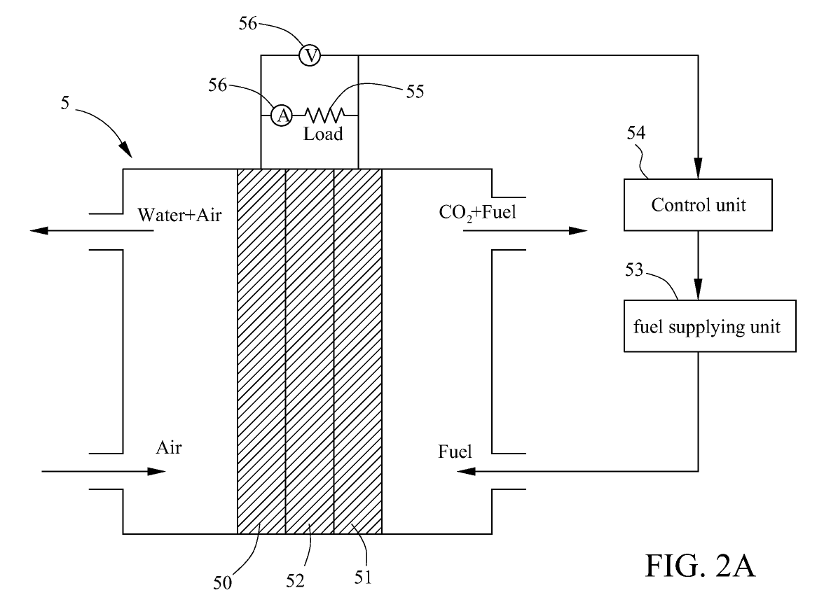

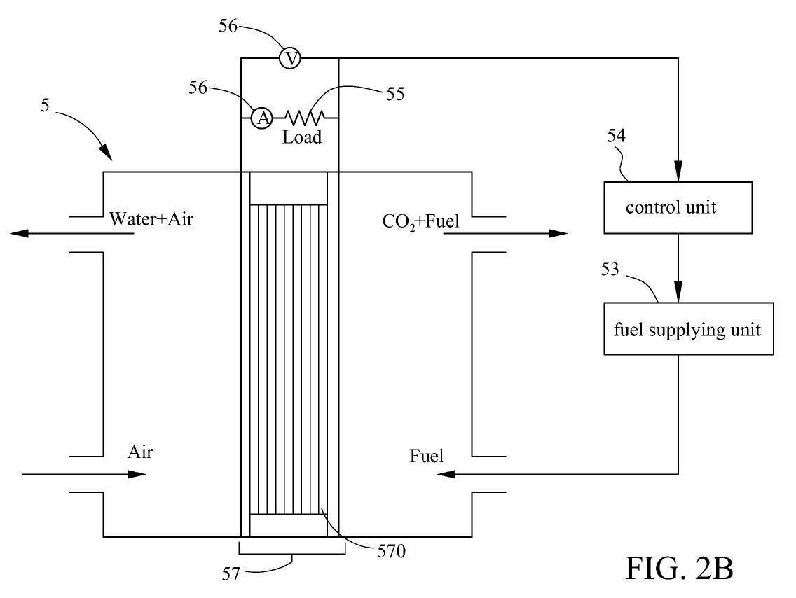

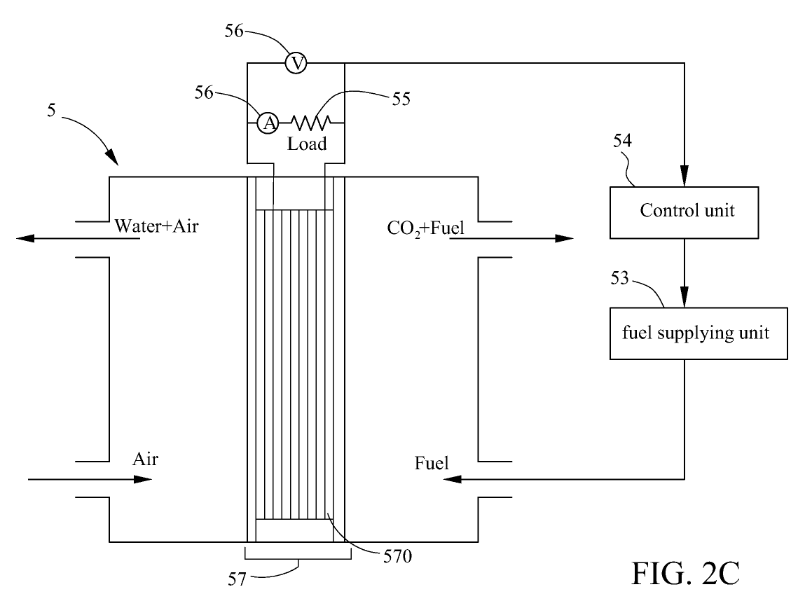

Please refer to FIG. 1, which is a flow chart depicting steps of a fuel sensor-less control method for supplying fuel to fuel cell according to a first embodiment of the invention. The fuel sensor-less control method for supplying fuel to fuel cell shown in FIG. 1 starts from step 10. At step 10, a determining process is performed for determining a specific fixed control amount for a fuel cell; and then the flow proceeds to step 11 for injecting a specific amount of fuel into the fuel cell. In this first embodiment, the fuel cell is structured as the one shown in FIG. 2A, which is configured with two tubing system, one being provided for a fuel, such as methanol, and oxygen to be supplied to the fuel cell therefrom while another one for draining water, carbon dioxide and other reactants. As shown in FIG. 2A, the core of the fuel cell 5 is a single fuel cell, which is comprised of an anode 51, a cathode 52 and a proton exchange membrane (PEM) 53. Moreover, there is a load to be used for connecting the anode 50 with the cathode 53 and thereby forms an electric circuit. However, as shown in FIG. 2B and FIG. 2C, instead of the signal fuel cell, the core of the fuel cell 5 can be a fuel cell stack 57 composing of a plurality of fuel cells 570 in that each fuel cell 570 is comprised of an anode, a cathode and a proton exchange membrane (PEM), similar to the one shown in FIG. 2A.

No matter the fuel cell is structured the same as the one shown in FIG. 2A, FIG. 2B or FIG. 2C, its load is connected to a measurement device 56, which is used for measuring specific characteristic values of the fuel cell. It is noted that the measurement device 56 can be a current meter or a voltage meter. In this first embodiment, a current meter is being adopted as the measurement device 56 so that it is serially connected with the load. However, if the measurement device 56 is a voltage meter, it should be parallel-connected to the load so as to be used for measuring voltage relating to the load. In addition, the fuel cell further has a control unit 54, which is used for receiving signals from the meter 56 so as to perform a calculation of numerical integration and logistic evaluation while issuing a control signal basing upon the calculation result to a fuel supplying unit 53 for enabling the same to perform a fuel supplying operation.

Preferably, the fuel provided by the fuel supplying unit 53 can be a hydrogen-rich fuel suitable for the fuel cell. For instance, the hydrogen-rich fuel for polymer electrolyte fuel cell (PEFC) should be a material selected from the group consisting of methanol, ethanol, and boron hydride. In addition, the hydrogen-rich fuel is not limited to be liquid as hydrogen can be used as fuel for proton membrane fuel cell (PEMFC) for instance. That is, the fuel used in the invention can be any fuel only if it is suitable for fuel cells. As in this embodiment the direct methanol fuel cell (DMFC) is used for illustration, methanol is used as the fuel in this embodiment.

Proceeding after the step 11 of FIG. 1 is the step 12, in which a time integral of a specific characteristic value resulting from the reaction of the fuel cell is obtained and used for determining a timing of fuel injection when the fuel cell is operating with the fuel supply under the fixed control amount of fuel. It is noted that the characteristic value, being a value selected from the group consisting of voltage, current, power and the combination thereof, is generated from a unit of the fuel cell whereas the power unit is a device selected from the group consisting of: a unit being composed of the whole fuel cell stack 57 as the one shown in FIG. 2B; a unit being a single cell as the one shown in FIG. 2A; and a unit composed of a portion of the fuel cells in the whole fuel cell stack as the one shown in FIG. 2C. As the load shown in FIG. 2A and FIG. 2B can be varying dynamically, the characteristic value of the operating fuel cell will be varying in respond to the dynamic variation of the load. Therefore, for adapting the fuel cell for the dynamic load, a function relating to the time integral of the characteristic value resulting from the reaction of the fuel cell when the fuel cell is operating with the fuel supply under the fixed control amount of fuel is obtained so as to be used for determining a timing for injecting fuel into the fuel cell. In this embodiment, the integral function for determining the timing for injecting fuel into the fuel cell is as following:

$$M ( {I}_{n} ) = G * {\int }_{Ta}^{Tb} {I}_{n} \times R d t ; and R = \frac{{η}_{fuel} ( {I}_{r} )}{{η}_{fuel} ( {I}_{n} )} \qquad ( 1 )$$

wherein, M(Iₙ) is the amount of fuel to be injected from step 11, in unit of g;
   t is the monitoring period, in unit of sec, i.e. the period of time required for the time integral to reach the amount of M(Iₙ);
   Tₐ is the time when the fuel is started to be injected into the fuel cell;
   T_{b} is the time when the time integral is equal to the fixed control amount;
   Iᵣ is the characteristic value specified for the fuel cell;
   Iₙ is the characteristic value of the fuel cell, in unit of amp as it is the load current of the fuel cell system;
   μ_{fuel}(Iᵣ) represents fuel utilization at load Iᵣ; and
   G (Gain Factor) is a function related to the electron transfer number n of the fuel cell's electrochemical reaction, the Faraday constant F (96480 A s mol⁻¹), and system configurations of the fuel cell such as MEA, channel types, output wattage, the amount of each injection, and the duration of the monitoring period, and so on.

In the embodiment of FIG. 1, the time integral described in step 12 is obtained according to the integral function (1). Accordingly, as soon as the time integral is equal to the fixed control amount, i.e. when the integration reaches T_{b}, the step 13 shown in FIG. 1 is performed for injecting the fixed control amount of fuel into the fuel cell. Although current is used as the characteristic value in this embodiment, it is not limited thereby and thus can be voltage or power of the fuel cell. As for the fixed control amount, it is often being determined according to actual requirement and thus being determined according to experimental results. Therefore, the fixed control amount can be determined by those skilled in the art according to actual requirement without any limitation.

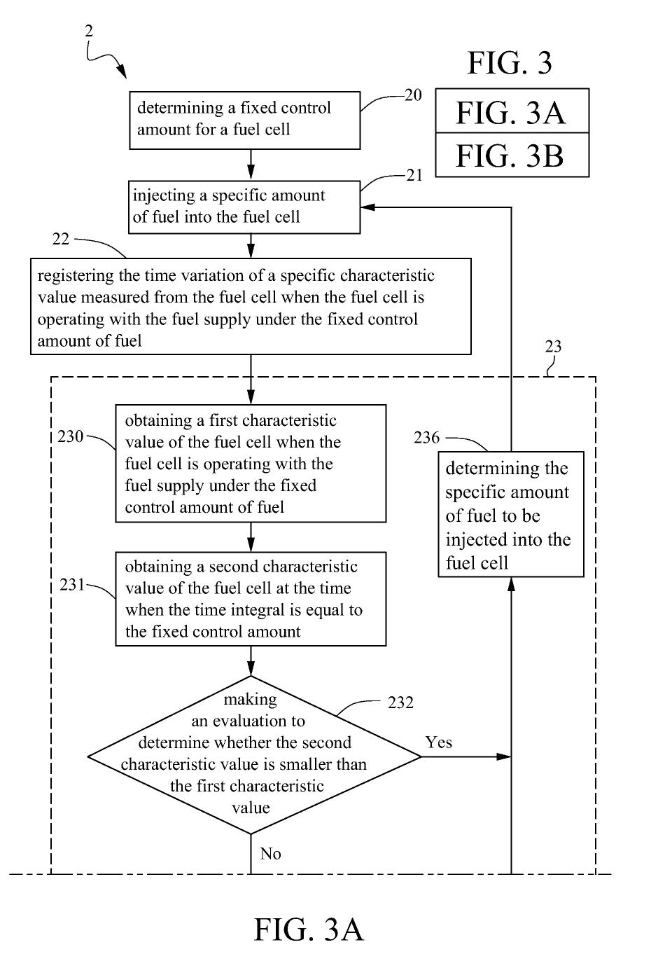

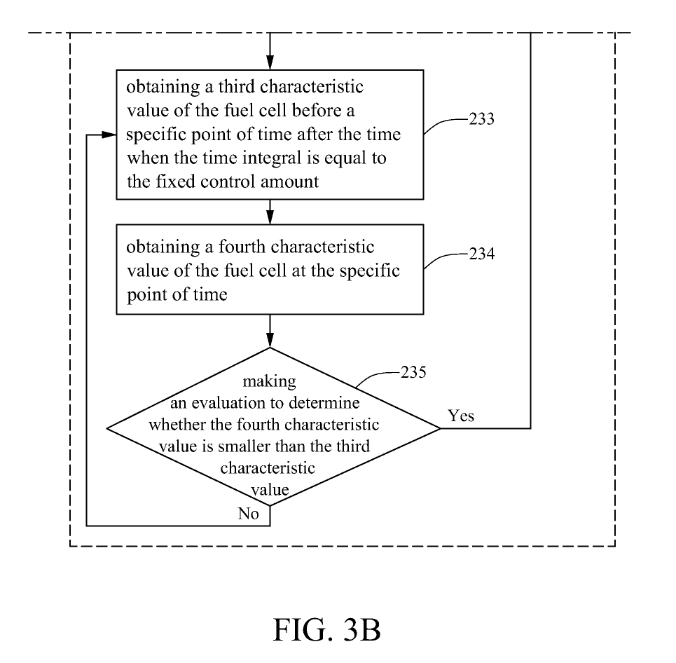

Please refer to FIG. 3, which is a flow chart depicting steps of a fuel sensor-less control method for supplying fuel to fuel cell according to a second embodiment of the invention. The flow of the fuel supplying method 2 starts from the step 20. At the step 20, a fixed control amount of fuel is injected into a fuel cell; and then the flow proceeds to step 21. It is noted that, in this second embodiment, the fixed control amount of fuel is a specific amount of fuel being injected into the fuel cell for one monitoring period without considering the delay of fuel injection, however, it can be determined according to actual requirement and is not limited by any restriction.

At step 21, a specific amount of a fuel is injected into the fuel cell as the specific amount is designated to be the fixed control amount; and then the flow proceeds to step 22. Moreover, the fuel cell in this embodiment is structured similar to that shown in FIG. 2A or FIG. 2B so that no further description relating to its configuration will be provided herein. In addition, the fuel is a hydrogen-rich fuel, such as methanol, ethanol, or boron hydride, etc. In addition, the hydrogen-rich fuel is not limited to be liquid as hydrogen can be used as the fuel in PEMFC. In this embodiment, the fuel to be used is methanol. At step 22, the variation of a specific characteristic value measured from the fuel cell is registered when the fuel cell is operating with the fuel supply under the fixed control amount of fuel; and then the flow proceeds to step 23. At step 23, an evaluation is performed for evaluating the variation trend of the specific characteristic value at the time when the obtained time integral is equal to the fixed control amount and to be used as a reference for determining whether to inject fuel into the fuel cell or not, according to the aforesaid integral function (1).

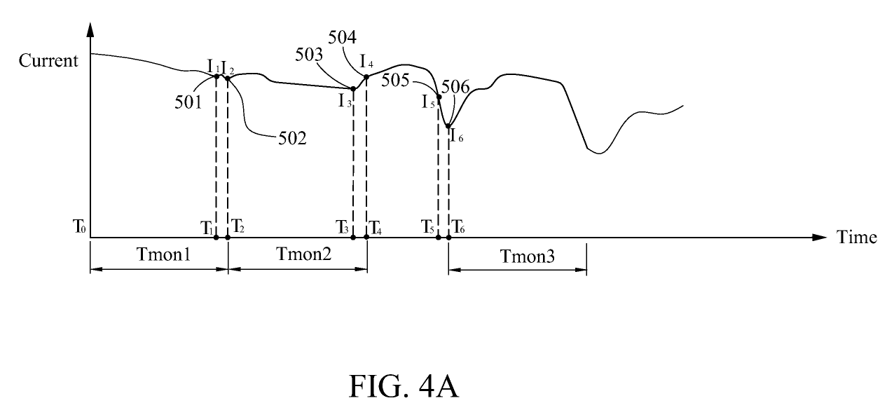

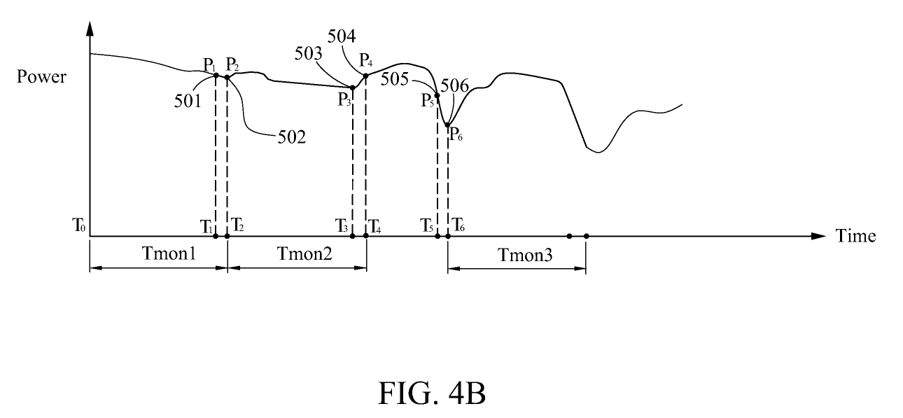

For clarifying the happening in the step 23, please refer to FIG. 4A, which plots a current curve of a fuel cell operating under the fuel supplying method of the invention. As the characteristic value is defined to be current in the step 22, the curve profiling the characteristic value of the fuel cell is the curve shown in FIG. 4A. As shown in FIG. 3, the step 23 is comprised of a plurality of sub-steps which starts at the step 230. At step 230, a first characteristic value of the fuel cell is obtained when the fuel cell is operating with the fuel supply under the fixed control amount of fuel; and then the flow proceeds to step 231. The first characteristic value is a value selected from the group consisting of: the minimum voltage measured during the fuel cell is operating with the fuel supply under the fixed control amount of fuel, the minimum current measured during the fuel cell is operating with the fuel supply under the fixed control amount of fuel, the minimum power measured during the fuel cell is operating with the fuel supply under the fixed control amount of fuel, and the combination thereof. In this exemplary embodiment, the first characteristic value, being defined as the power of the fuel cell, can be current or voltage measured from the fuel cell, in which as power is the product of current and voltage, it is preferred for its enhanced resolution in logistically analyzing the module's performance. Please refer to FIG. 4B, which plots a power curve of a fuel cell operating under the fuel supplying method of the invention. Generally, the performance of a fuel cell in the laboratory may be experimentally evaluated under constant voltage, constant current, or constant resistance modes with an electronic load. For instance, when a fuel cell is used as the power supply of notebook and is parallel-connected with a Lithium-ion battery to form a hybrid power source, it is likely that the system is performing under constant resistance mode so that the power curve and the voltage curve basically are conforming to the current curve as the one shown in FIG. 4A. As shown in FIG. 4B, because the power output of the fuel cell is given by the product of voltage and current, the use of power as the characteristic value of the fuel cell can enhance control resolution and accuracy. However, in reality, the fuel cell is not limited to operate under constant current mode or constant voltage mode. In the embodiment shown in FIG. 4B, the first characteristic value is defined to be the minimum power measured during the fuel cell is operating with the fuel supply under the fixed control amount of fuel, which is substantially the power P₁ measured at point 501. In addition, the first characteristic value can be selected from the group consisting of: a moving average of characteristic values associated with a time zone obtained in a period when the fuel cell is operating with the fuel supply under the fixed control amount of fuel, a root mean square (RMS) of the characteristic values associated with a time zone obtained in a period when the fuel cell is operating with the fuel supply under the fixed control amount of fuel; and statistic values calculated by performing other mathematical operations upon characteristic values associated with the time zone, and so on.

At step 231, a second characteristic value of the fuel cell is obtained at the time when the time integral is equal to the fixed control amount; and then the flow proceeds to step 232. It is noted that the second characteristic value can be selected from the group consisting of current measured from the fuel cell, voltage measured from the fuel cell, power measured from the fuel cell, and the combination thereof. In the embodiment shown in FIG. 4B, the second characteristic value is defined as the power, which is substantially the power P₂ measured at point 502. At step 232, an evaluation is made to determine whether the second characteristic value is small than the first characteristic value; if so, then the flow proceeds back to step 236 for determining a specific amount of fuel to be inject into the fuel cell as the fuel had been exhausted to a certain extent, and the amount of fuel to be injected is determined according to the integral function (1); otherwise, the flow proceeds to step 233 as there is still excess fuel remaining in the fuel cell. That is, at the time when the second characteristic value is smaller than the first characteristic value, the time integral obtained from step 236 is used as the fixed control amount to be injected into the fuel cell; and on the other hand, when the second characteristic value is larger than the first characteristic value, it represents that there is still plenty of fuel in the fuel cell and thus no fuel injection is required. For example, in FIG. 4B, as the power P₁ measured at point 501 is larger than the power P₂ measured at point 502, it represents that the fuel in the fuel cell had been exhausted to an extent that the fuel cell will be no longer able to operate and requires to be feed with fuel. At step 236, the specific amount of a fuel to be injected into the fuel cell is determined according to the measurement of a function relating to the time integral of the characteristic values resulting from the reaction of the fuel cell during the monitoring, i.e. the integral function (1) as Tₐ=T_{O},T_{b}=T₂.

After injecting fuel into the fuel cell, the flow is directed back to perform the step 21, step 22 and then the step 23 again for lasting another fixed control amount monitoring, in which the step 230 and the step 231 are performed before the end of the new monitoring period Tₘₒₙ₂, i.e. before the time T₄. In this embodiment, the first characteristic value is defined to be the minimum power measured during the second monitoring period Tₘₒₙ₂, which is substantially the power P₃ measured at point 503; and the second characteristic value is defined to be the power P₄ measured at point 504. Thereafter, the two obtained characteristic value is compared in the step 232 for evaluating whether the second characteristic value is smaller than the first characteristic value. As shown in FIG. 4B, the power P₃ measured at point 503 is smaller than the power P₄ measured at point 504 so that there is still excess fuel remaining in the fuel cell and thus step 233 will be proceeded.

At step 233, a third characteristic value of the fuel cell is obtained at a time point T₅ before a specific point of time T₆ after the end of the second monitoring period, which is defined as the power P₅ measured at point 505; and then the flow proceeds to step 234. At step 234, a fourth characteristic value of the fuel cell is obtained at the specific point of time T₆, which is defined as the power P₆ measured at point 506; and then the flow proceeds to step 235. At the step 235, an evaluation is made to determine whether the fourth characteristic value is small than the third characteristic value; if so, the flow proceeds to step 236; otherwise, the flow proceeds to step 233. In the embodiment shown in FIG. 4B, as the power P₆ is smaller than the power P₅, the step 236 will be performed for determining a specific amount of a fuel to be injected into the fuel cell according to the fixed control amount and the measurement of a function relating to the time integral of the characteristic values during the monitoring period between the proceeding of the step 233 to step 236, and the integral function is as following:

$$M ( {I}_{n} ) = G \times {\int }_{Ta}^{Tb} {I}_{n} \times R d t + k \times G \times {\int }_{Tb}^{Tc} {I}_{n} \times R d t ; and R = \frac{{η}_{fuel} ( {I}_{r} )}{{η}_{fuel} ( {I}_{n} )} \qquad ( 2 )$$

wherein, G×∫_{Ta}^{Tb}Iₙ×Rdt is the fixed control amount;
k is a compensation factor for compensating the fuel consumption during the fuel injection delay period; and 0≦k≦1; and
k×G×∫_{Tb}^{Tc}Iₙ×Rdt is the time integral of the characteristic values during the monitoring period between the proceeding of the step 233 to step 236 as T_{b}=T₄,T_{c}=T₆.

At this time, since the whole process had already exceeded the time range defined in the aforesaid integral function (2), the characteristic values obtained during the monitoring period between the proceeding of the step 233 to step 236 will be used for defining the amount of fuel that is being prepared for injecting into the fuel cell in the next monitoring period. In this embodiment, the current characteristic value is integrated between the time point T₂ and T₄, and T₄ and T₆. After the step 236 is complete, the flow will be directed back to the step 21 for starting another cycle of monitoring. On the other hand, when the fourth characteristic value is larger than the third characteristic value, it represents that there is still excess fuel remaining in the fuel cell so that the flow is directed back to the step 233 for staring another cycle of monitoring by obtaining new third and fourth characteristic values and thus the fuel supply of the fuel cell is under constant monitoring and adjustment for sustaining the fuel cell to operate continuously and normally. It is noted that the interval between the point 505 and the point 506 is specified to be one second, but is not limit thereby.

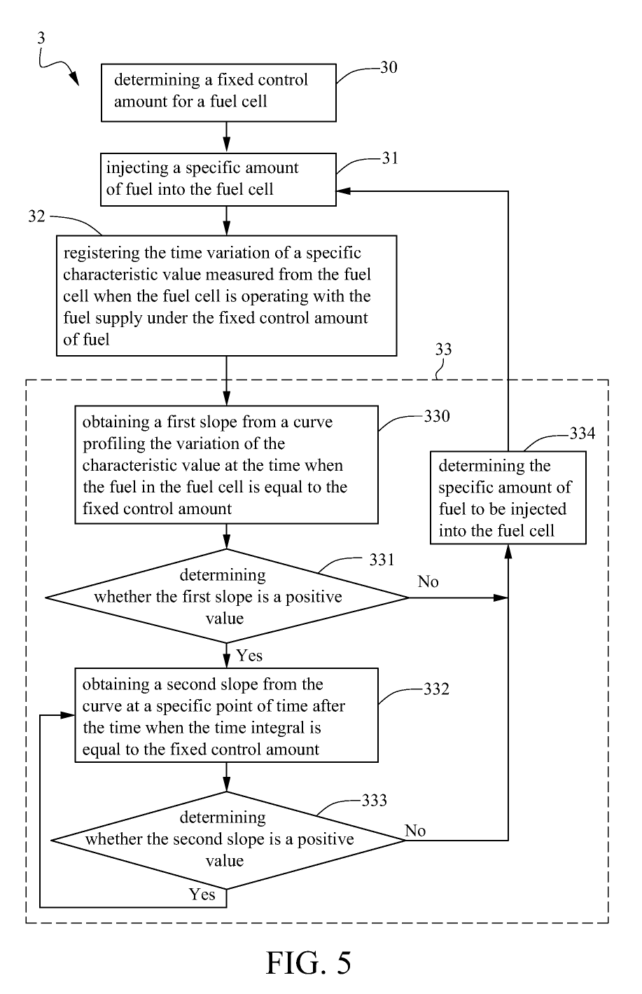

Please refer to FIG. 5, which is a flow chart depicting steps of a fuel sensor-less control method for supplying fuel to a fuel cell according to a third embodiment of the invention. In the third embodiment, the step 30 to step 32 are the same as those described in the second embodiment while the only difference is in the step 33, in that the determination of whether the fuel cell has exhausted its fuel is based on an evaluation for determining whether a slope is a positive value or a negative value. At step 330, a first slope is obtained from a curve profiling the variation of the characteristic value when the fuel cell is operating under the fixed control amount; and then the flow proceeds to step 331. At step 331, an evaluation is made for determining whether the first slope is a positive value; if so, then the flow proceeds to step 332; otherwise, the flow proceeds back to step 334 for determining a specific amount of a fuel to be injected into the fuel cell according to the measurement of a function relating to the time integral of the characteristic values resulting from the reaction of the fuel cell during the monitoring, i.e. the integral function (1); and then the flow proceeds back to the step 31 where the specific amount of fuel is injected into the fuel cell. At step 332, a second slope is obtained from the curve profiling the variation of the characteristic value at a specific point of time after the time when the time integral is equal to the fixed control amount; and then the flow proceeds to step 333. At step 333, an evaluation is made to determine whether the second slope is a positive value; if so, then the flow proceeds to step 332; otherwise, the flow proceeds back to step 334 for determining a specific amount of a fuel to be injected into the fuel cell according to the measurement of a function relating to the time integral of the characteristic values resulting from the reaction of the fuel cell during the monitoring, i.e. the integral function (2); and then the flow proceeds back to the step 31 where the specific amount of fuel is injected into the fuel cell.

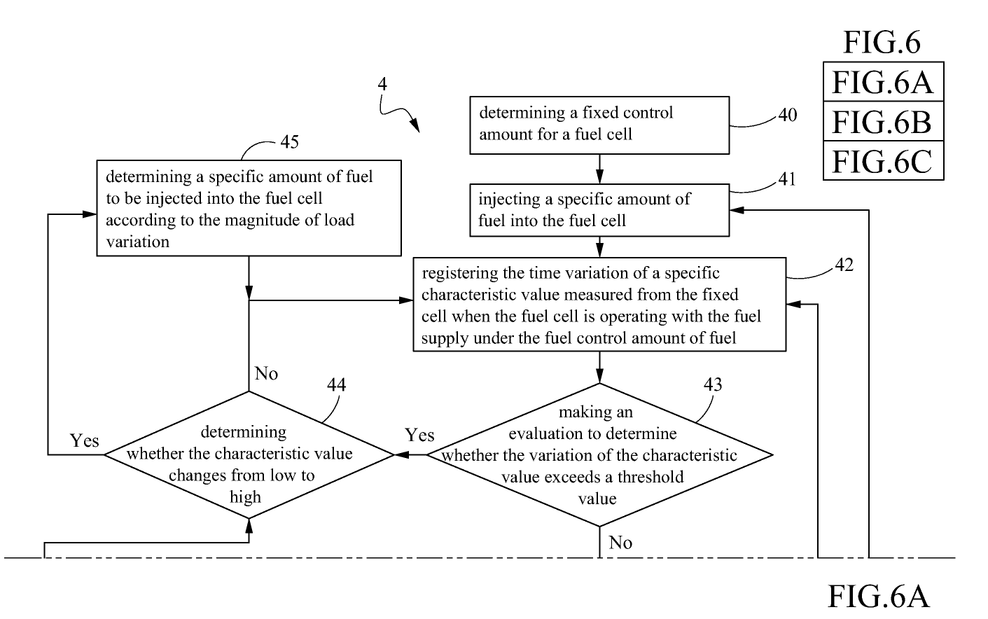

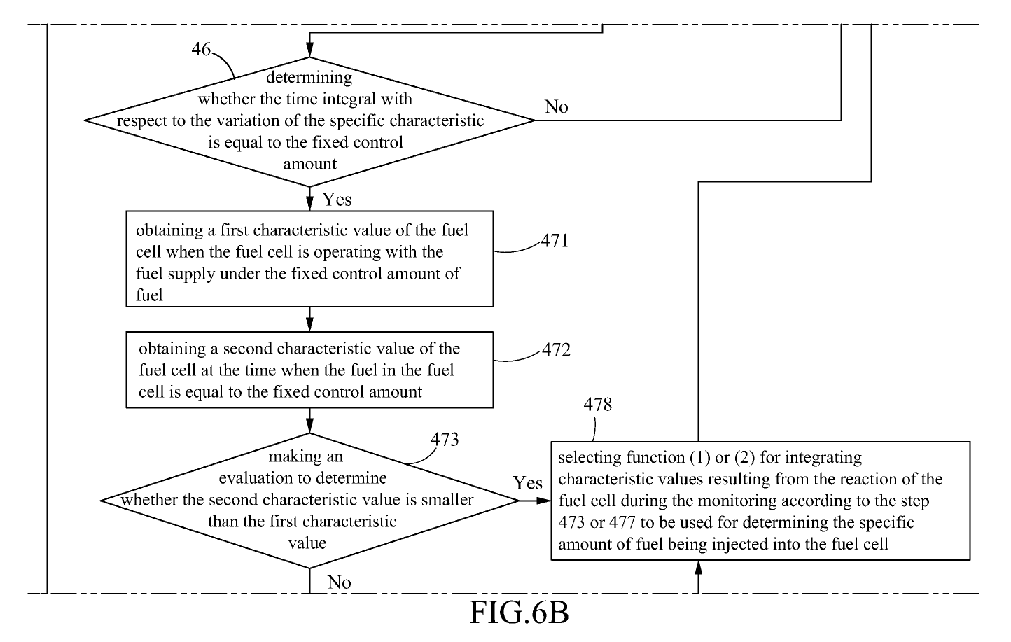

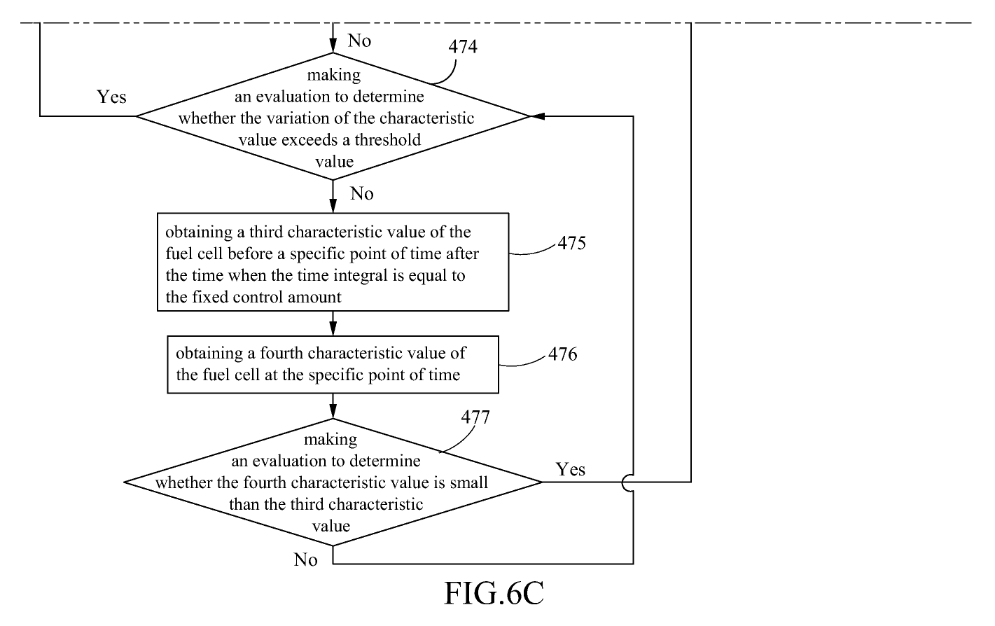

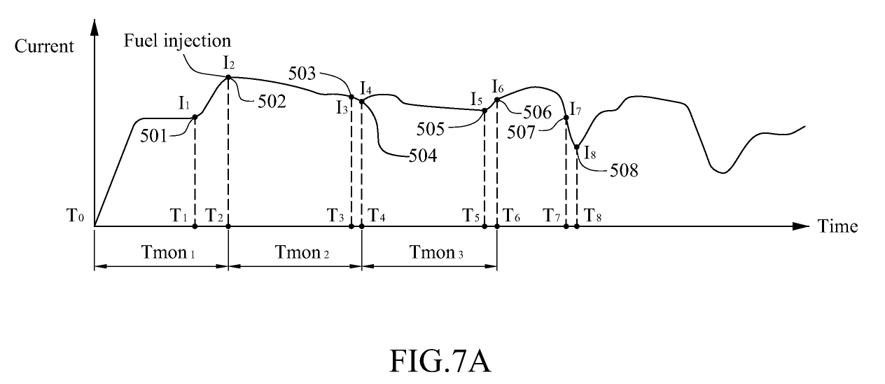

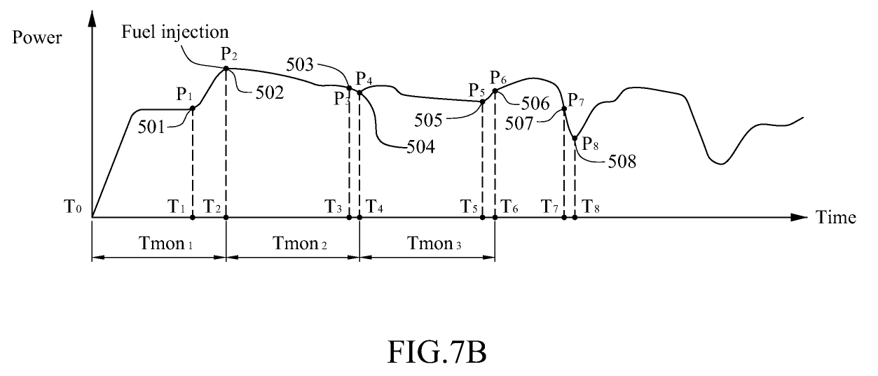

The aforesaid embodiments only illustrates the conditions when the load is varying within a small range, the present invention also provide a fuel supplying method adapted for the fuel cell subjecting to a load of large variation. Please refer to FIG. 6, FIG. 7A and FIG. 7B, which are flow chart depicting steps of a method for supplying fuel to fuel cell according to a fourth embodiment of the invention and two diagrams plotting respectively a current curve and a power curve of a fuel cell operating under the fuel supplying method of the invention. The flow of the fuel supplying method 4 starts from the step 40. At the step 40, a fixed control amount of fuel is determined for a fuel cell; and then the flow proceeds to step 41. It is noted that, in this fourth embodiment, the fixed control amount is a specific amount of fuel to be injected into the fuel cell. At step 41, the specific amount of fuel is injected into the fuel cell; and then the flow proceeds to step 42.

At step 42, the variation of specific characteristic values measured from the fuel cell are registered when the fuel cell is operating with the fuel supply under the fixed control amount of fuel; and then the flow proceeds to step 43. At step 43, an evaluation is made to determine whether the percentage of variation of the characteristic value exceeds a threshold value; if so, the flow proceeds to step 44; otherwise, the flow proceeds to step 460. It is noted that the threshold value in this embodiment is defined to be 20%, so that when the percentage of variation, calculated by the formula as following: (I₂−I_{I})/I₁*100%, is larger than 20%, the flow will be directed to the step 44. Moreover, the threshold value can be determined according to actual condition and experience, and thus is not limited to be 20%. In FIG. 7A, in the duration of the specific monitoring period, as the variation of characteristic value measured between the point 501 and the point 502 exceeds the threshold value, i.e. the variation between the current I₁ measured at the point 501 of time T₁ and the current I₂ measured at the point 502 of time T₂ exceeds 20%, the flow proceeds to the step 44 for determining whether the characteristic value changes from low to high. The changing of the characteristic value performed in the step 44 can be performed by determining whether the difference between the current I₁ measured at the point 501 and the current I₂ measured at the point 502 is a positive value or a negative value, or by determining the slope of the curve between the point 501 and the point 502 is a positive value or a negative value. It is noted that the time interval (T₂-T₁) between the point 501 and the point 502 can be determined according to the actual variation of the load.

In FIG. 7A, as the current I₂ is larger than the current I₁, the characteristic value is changing from low to high and thus the flow proceeds to step 45 for a specific amount of fuel to be injected into the fuel cell according to the magnitude of load variation; and then the flow

proceeds back to the step 42. Thereby, the method is able to instantly response to a load of large variation. for supplying fuel to the fuel cell according to the variation between I₁ and I₂ as well as the experiment data. On the other hand, when the characteristic value is not changed from low to high, there will be no fuel injection required and the flow is directed back to the step 42 for continuing the characteristic value monitoring. In this embodiment, as there is no certain load increasing during its second monitoring period Tₘₒₙ₂, the flow will proceeds to step 46 where an evaluation is performed for determining whether the time integral with respect to the variation of the specific characteristic, i.e. the integral of function (1), is equal to the fixed control amount; if so, the flow proceeds to step 471; otherwise, the flow proceeds back to step 42.

At step 471, a first characteristic value is obtained which is the power P₃ measured at the point 503; and then the flow proceeds to step 472. At step 472, a second characteristic value is obtained which is the power P₄ measured at the point 504; and then the flow proceeds to step 473. At step 473, an evaluation is made to determine whether the second characteristic value is small than the first characteristic value; if so, the flow proceeds to step 478; otherwise, the flow proceeds to step 474. As shown in FIG. 7B, the power P₄ measured at the point 504 is smaller than the power P₃ measured at the point 503 which indicates that the fuel is not sufficient for sustaining the operation of the fuel cell, and thus the step 478 is performed for determining a specific amount of a fuel to be injected into the fuel cell according to the measurement of a function relating to the time integral of the characteristic values resulting from the reaction of the fuel cell during the monitoring, i.e. the integral function (1); and then the flow proceeds back to step 41 for repeating the monitoring.

As the embodiment shown in FIG. 7B, there is no large variation relating to the load during the third monitoring period Tₘₒₙ₃ so that the flow will proceeds to the step 46. At the step 460, a first characteristic value is obtained which is the power P₅ measured at the point 505; and then the flow proceeds to step 471. At step 471, a first characteristic value is obtained which is the power P₅ measured at the point 505; and then the flow proceeds to step 472. At step 472, a second characteristic value is obtained which is the power P₆ measured at the point 506; and then the flow proceeds to step 473. At step 473, an evaluation is made to determine whether the second characteristic value is small than the first characteristic value; if so, the flow proceeds to step 487; otherwise, the flow proceeds to step 474. As shown in FIG. 7B, the power P₆ measured at the point 506 is larger than the power P₅ measured at the point 505 which indicates that the fuel is still sufficient for sustaining the operation of the fuel cell, and thus the step 474 is performed. At step 474, an evaluation is being made for determining whether the variation of the characteristic value exceeds a threshold value; if so, the flow proceeds back to the step 44; otherwise, the flow proceeds to step 475. At step 475, a third characteristic value of the fuel cell is obtained at a time point T, before a specific point of time T₈ after the end of the monitoring period; and then the flow proceeds to step 476. At step 476, a fourth characteristic value of the fuel cell is obtained at the specific point of time T₈; and then the flow proceeds to step 477. At the step 477, an evaluation is made to determine whether the fourth characteristic value is small than the third characteristic value; if so, the flow proceeds to step 478; otherwise, the flow proceeds to step 474. In the embodiment shown in FIG. 7B, as the power P₈ is smaller than the power P₇, the step 478 will be performed for determining a specific amount of a fuel to be injected into the fuel cell according to the measurement of a function relating to the time integral of the characteristic values resulting from the reaction of the fuel cell during the monitoring, i.e. the integral function (2). In this embodiment, the current characteristic value is integrated between the time point T₄ and T₆ for the first term of the integral function (2) and between T₆ and T₈ for the second term of the integral function (2). After the step 477 is complete, the flow will be directed back to the step 41 for starting another cycle of monitoring. On the other hand, when the fourth characteristic value is larger than the third characteristic value, it represents that there is still excess fuel remaining in the fuel cell so that the flow is directed back to the step 475 for staring another monitoring by obtaining new third and fourth characteristic values and thus the fuel supply of the fuel cell is under constant monitoring and regulation for sustaining the fuel cell to operate continuously and normally. It is noted that the interval between the point 505 and the point 506 is specified to be one second, but is not limit thereby.

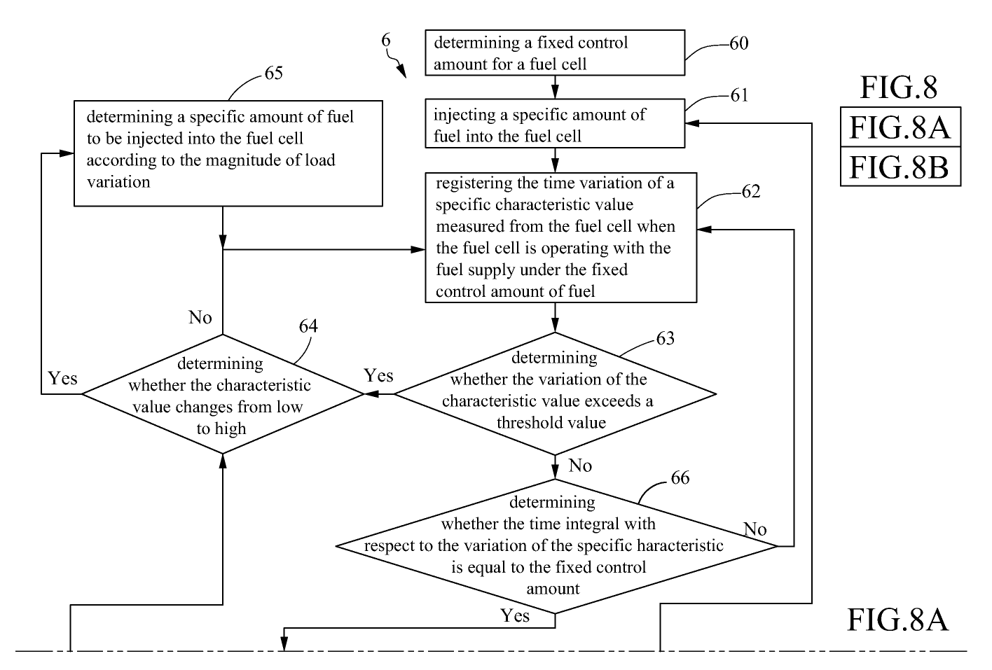

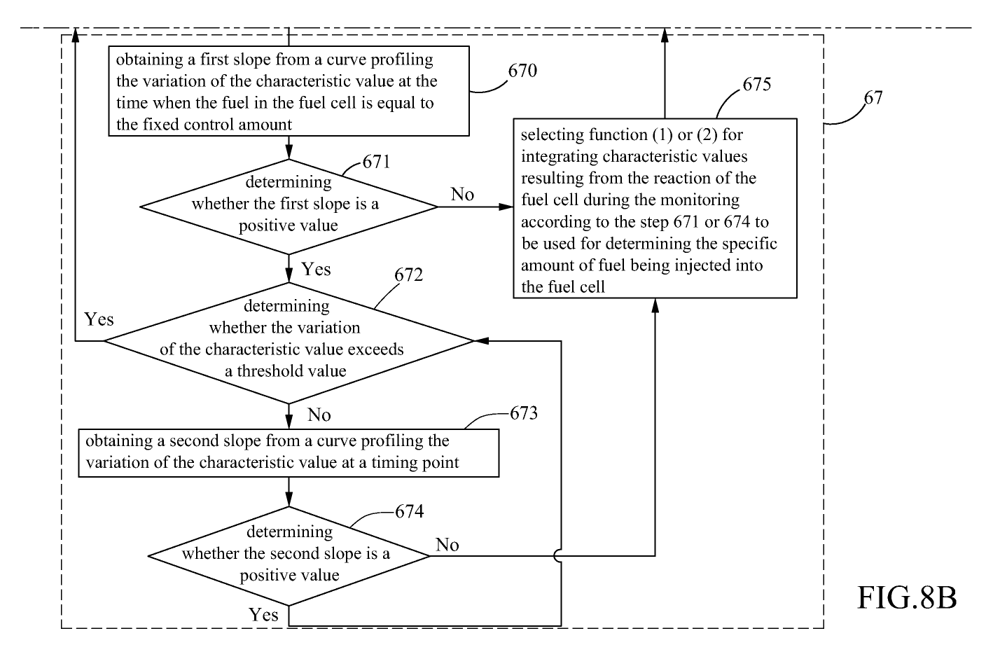

Please refer to FIG. 8, which is a flow chart depicting steps of a method for supplying fuel to fuel cell according to a fifth embodiment of the invention. The fuel supplying method of FIG. 8 is basically the same as that shown in FIG. 6, but is different in that: the comparison of characteristic value is replaced by the comparison of slope. Taking the characteristic curve shown in FIG. 7B for example, after the time integral is determined to be equal to the fixed control amount by the proceeding of step 66 for enabling the flow to proceed to step 670 in that a first slope is obtained at the point P₄ of the curve profiling the variation of the characteristic value at the end of the specific monitoring period, i.e. T₄; and then the flow proceeds to step 671 where it is determined whether it is a positive value or not. If it is positive which indicates that there is still sufficient fuel in the fuel cell and no need for fuel supplying, the flow will proceeds to step 672; otherwise, the flow will proceeds to the step 675 for determining the amount of fuel to be injected into the fuel cell as the fuel is not sufficient indicating by the negative slope. At step 675, a specific amount of a fuel is determined to be injected into the fuel cell according to the integral function (1).

When the slope is positive, the step 672 will be performed as the positive slope is measured at the point P₆ of the curve at time T₆ shown in the embodiment of FIG. 7B so that another evaluation is made for further determining whether the variation of the characteristic value exceeds a threshold value. Thus, at step 672, an evaluation is made for further determining whether the variation of the characteristic value exceeds a threshold value; if so, the flow proceeds back to step 64; otherwise, the flow proceeds to step 673. At step 673, a second slope is obtained from a curve profiling the variation of the characteristic value at the end of another specific monitoring period continuing the aforesaid monitoring period; and then the flow proceeds to step 674. At step 674, an evaluation is performed for determining whether the second slope is a positive value; if so which indicates that there is still sufficient fuel in the fuel cell and no need for fuel supplying, the flow will proceeds to step 672; otherwise, the flow will proceeds to the step 675 for determining the amount of fuel to be injected into the fuel cell as the fuel is not sufficient indicating by the negative slope, as the slope measured at the point P₇ of the curve at time T₇ in FIG. 7B. At step 675, a specific amount of a fuel is determined to be injected into the fuel cell according to the integral function (2).

With respect to the under description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. A fuel sensor-less control method for supplying fuel to a fuel cell, comprising the steps of:
(a) injecting a fixed control amount of fuel into a fuel cell as the fuel cell, being subjected to a load, is comprised of: at least one cell, each composed of an anode, a cathode and a proton exchange membrane; and
(b) obtaining a time integral of a specific characteristic value resulting from the reaction of the fuel cell to be used for determining a timing of fuel injection when the fuel cell is operating with the fuel supply under the fixed control amount of fuel.

2. The fuel sensor-less control method of claim 1, wherein the characteristic value is selected from the group consisting of current measured from the fuel cell, voltage measured from the fuel cell, power measured from the fuel cell, and the combination thereof.

3. The fuel sensor-less control method of claim 1, wherein the characteristic value is generated from a power unit of the fuel cell and the power unit is a device selected from the group consisting of: a unit being composed of the whole fuel cell stack; and a unit composed of a portion of the cells in the whole fuel cell stack.

4. A fuel sensor-less control method for supplying fuel to a fuel cell, comprising the steps of:
(a) injecting a fixed control amount of fuel into a fuel cell as the fuel cell, being subjected to a load, is comprised of: at least one cell, each composed of an anode, a cathode and a proton exchange membrane;
(b) registering the time variation of a specific characteristic value measured from the fuel cell when the fuel cell is operating with the fuel supply under the fixed control amount of fuel; and
(c) evaluating the variation trend of the specific characteristic value at the time when a time integral relating to a curve profiling the time variation is equal to the fixed control amount to be used as a reference for determining whether to inject fuel into the fuel cell or not.

5. The fuel sensor-less control method of claim 4, wherein the evaluating of the variation trend of the specific characteristic value further comprising the steps of:
(c1) obtaining a first characteristic value from the specific characteristic value of the fuel cell before the time integral is equal to the fixed control amount;
(c2) obtaining a second characteristic value from the specific characteristic value of the fuel cell at the time when the time integral is equal to the fixed control amount; and
(c3) making a comparison between the second characteristic value and the first characteristic value for performing a fuel supplying operation to inject the fixed control amount of fuel into the fuel cell if the second characteristic value is smaller than or equal to the first characteristic value; otherwise, performing a judgment operation if the second characteristic value is larger than the first characteristic value.

6. The fuel sensor-less control method of claim 5, wherein the first characteristic value is a value selected from the group consisting of the minimum voltage measured during the fuel cell is operating with the fuel supply under the fixed control amount of fuel, the minimum current measured during the fuel cell is operating with the fuel supply under the fixed control amount of fuel, the minimum power measured during the fuel cell is operating with the fuel supply under the fixed control amount of fuel, and the combination thereof.

7. The fuel sensor-less control method of claim 5, wherein any one of the first characteristic value and the second characteristic value is generated from a power unit of the fuel cell and the power unit is a device selected from the group consisting of: a unit being composed of the whole fuel cell stack; and a unit composed of a portion of the cells in the whole fuel cell stack.

8. The fuel sensor-less control method of claim 5, wherein the first characteristic value is a moving average of characteristic values associated with a time zone obtained in a period when the fuel cell is operating with the fuel supply under the fixed control amount of fuel.

9. The fuel sensor-less control method of claim 5, wherein the first characteristic value is a root mean square (RMS) of the characteristic values associated with a time zone obtained in a period when the fuel cell is operating with the fuel supply under the fixed control amount of fuel.

10. The fuel sensor-less control method of claim 5, wherein the judgment operation further comprises the steps of:
(c4) obtaining a third characteristic value from the specific characteristic value of the fuel cell before a specific point of time after the time when the time integral is equal to the fixed control amount;
(c5) obtaining a fourth characteristic value from the specific characteristic value of the fuel cell at the specific point of time;
(c6) making a comparison between the third characteristic value and the fourth characteristic value for performing a fuel supplying operation to inject fuel into the fuel cell if the fourth characteristic value is small than or equal to the third characteristic value; and
(c7) proceeding back to step (c4) when the fourth characteristic value is larger than the third characteristic value.

11. The fuel sensor-less control method of claim 10, wherein the third characteristic value is a moving average of characteristic values associated with a time zone before the specific point of time.

12. The fuel sensor-less control method of claim 10, wherein the third characteristic value is a root mean square (RMS) of the characteristic values associated with a time zone before the specific point of time.

13. The fuel sensor-less control method of claim 10, wherein the third characteristic value is the minimum of the characteristic value measured from the fuel cell associated with a time zone before the specific point of time.

14. The fuel sensor-less control method of claim 10, wherein the amount of fuel being injected into the fuel cell performed in the step (c6) is determined according to the combination of the fixed control amount and the measurement of a function relating to the time integral of the characteristic values resulting from the reaction of the fuel cell during a period between the proceeding of the step (c4) to the step (c6).

15. The fuel sensor-less control method of claim 10, wherein any one of the third characteristic value and the fourth characteristic value is generated from a power unit of the fuel cell and the power unit is a device selected from the group consisting of: a unit being composed of the whole fuel cell stack; and a unit composed of a portion of the fuel cells in the whole fuel cell stack.

16. The fuel sensor-less control method of claim 4, wherein the characteristic value is selected from the group consisting of current measured from the fuel cell, voltage measured from the fuel cell, power measured from the fuel cell, and the combination thereof.

17. The fuel sensor-less control method of claim 4, wherein the evaluating of the variation trend of the specific characteristic value further comprising the steps of:
(c1) obtaining a first slope from a curve profiling characteristic value of the fuel cell at the time when the time integral is equal to the fixed control amount;
(c2) performing a fuel supplying operation to inject fuel into the fuel cell if the first slope is a negative value; otherwise, proceeding to step (c3) when the first slope is a positive value;
(c3) obtaining a second slope from the characteristic curve of the fuel cell before a specific point of time after the time when the time integral is equal to the fixed control amount; and
(c4) determining whether the second slope is a negative value while performing the fuel supplying operation to inject fuel into the fuel cell when the second slope is negative; otherwise, the flow proceeds back to step (c3) when the second slope is positive.

18. The fuel sensor-less control method of claim 17, wherein the amount of fuel being injected into the fuel cell performed in the step (c4) is determined according to the combination of the fixed control amount and the measurement of a function relating to the time integral of the characteristic values resulting from the reaction of the fuel cell during a period between the proceeding of the step (c3) to the step (c4).

19. The fuel sensor-less control method of claim 4, wherein the fuel is a hydrogen-rich fuel.

20. The fuel sensor-less control method of claim 19, wherein the hydrogen-rich fuel is a fuel selected from the group consisting of: methanol, ethanol, and boron hydride.

21. The fuel sensor-less control method of claim 19, wherein the hydrogen-rich fuel is hydrogen.

22. The fuel sensor-less control method of claim 4, wherein the measuring of the variation of the specific characteristic value in the step (b) further comprises the steps of:
(b1) making an evaluation to determine whether the specific characteristic value is varied; and
(b2) determining whether to perform the fuel supplying operation to inject fuel into the fuel cell according to the variation of the load when the specific characteristic value is varied.

23. The fuel sensor-less control method of claim 22, wherein the load is determined to be varied when the characteristic value of the fuel cell changes from low to high.

24. The fuel sensor-less control method of claim 23, wherein the changing of the characteristic value is determined by a means selected from the group consisting of: the characteristic value changes from low to high when a slope obtained from a curve profiling the variation of the characteristic value is a positive value; the characteristic value changes from high to low when the slope obtained from the curve profiling the variation of the characteristic value is a negative value; the characteristic value from high to low is determined by evaluating whether the difference of characteristic values measured before a specific point of time and at the specific point of time is positive; and the characteristic value from low to high is determined by evaluating whether the difference of characteristic values measured before a specific point of time and at the specific point of time is negative.

25. The fuel sensor-less control method of claim 22, wherein the amount of fuel to be injected into the fuel cell is dependent upon the variation of the load.
